(19) United States
(12) Patent Application Publication
(10) Pub. No.: US 2023/0408413 A1
(43) Pub. Date: Dec. 21, 2023

(54) SINGLE SENSOR IMAGING SPECTROSCOPY FOR DETECTING NANOPARTICLES TO QUALIFY CLEAN CHAMBER PARTS

(71) Applicant: Applied Materials, Inc., Santa Clara, CA (US)

(72) Inventors: Viswanath BAVIGADDA, Bangalore (IN); Shubhayan BHATTACHARYA, Bangalore (IN); Tapashree ROY, Bangalore (IN); Ankur KADAM, Bangalore (IN); Kiran Rangaswamy AATRE, Bangalore (IN); Suraj RENGARAJAN, Bangalore (IN)

(21) Appl. No.: 18/334,186

(22) Filed: Jun. 13, 2023

Related U.S. Application Data
(60) Provisional application No. 63/353,342, filed on Jun. 17, 2022.

(51) Int. Cl. G01N 21/64; G01N 21/39

(52) U.S. Cl. CPC G01N 21/6456; G01N 21/643; G01N 21/39; G01N 2021/399; G01N 2201/0633; G01N 2201/1235; G01N 21/94

(57) ABSTRACT

In one embodiment, an apparatus to identify chemical and spatial properties of nanoparticles in a semiconductor cleaning solution, comprises a broadband light source to provide an excitation beam; a focusing lens in a path of the excitation beam to form a focused excitation beam; a sample cell, the sample cell configured to hold a cleaning solution and one or more insoluble analytes-of-interest therein; a plurality of optical lens in the path of one or more fluorescence signals to focus the one or more fluorescence signals; and an imaging device, wherein the imaging device captures the one or more fluorescence signals to form a plurality of images that contain both spatial data and spectral data about the one or more insoluble analytes-of-interest.

### CROSS-REFERENCE TO RELATED APPLICATIONS

This application claims benefit of U.S. provisional patent application Ser. No. 63/353,342, filed Jun. 17, 2022, which is herein incorporated by reference.

### BACKGROUND

### Field

Embodiments of the present disclosure generally relate to particle detection and, in particular, to analysis and detection of nanoparticles in a liquid from a semiconductor manufacturing component.

### Description of the Related Art

As semiconductor substrate processing moves towards increasingly smaller feature sizes and line-widths, the importance of masking, etching, and depositing material on a semiconductor substrate with greater precision increases.

However, as semiconductor features shrink the size of contaminant particles which can render the device inoperable also become smaller (e.g., 50 nanometers or less) and more difficult to remove. A typical semiconductor manufacturing chamber component cleaning process involves immersing a chamber component in a liquid cleaning solution and analyzing a sample of the cleaning solution to determine particle characteristics, such as the number of particles (particle count) and the composition of the particles (e.g. metal, oxides, ceramic, hydrocarbon, polymers).

Conventional monitoring apparatuses configured with liquid particle counter (LPC) tools are capable of detecting particle sizes of about 50 nm or greater. However LPC tools, which are based on dynamic light scattering (Rayleigh scattering), can only record the size distribution of scattering particles present in the cleaning solution and cannot deduce the nature or chemistry of the contaminant particles.

Since LPC tools do not provide any information about the chemical composition of the nanoparticles, a separate optical apparatus is conventionally needed. For example, the separate optical apparatus may include a tunable laser able to project a range of wavelengths in the UV-Visible region, a high resolution fluorescence imaging and spectroscopy device that can be used to chemically identify the nanoparticles, an arrangement of optical lens capable of diffracting the incident light projected onto the liquid sample from the tunable laser and into the spectroscopy device, and a charged coupled device (CCD) sensor. The multiple monitoring arrangements are both size and cost prohibitive.

Therefore, there is a need for improved apparatus and methods for monitoring and/or detecting particle contamination.

### SUMMARY

Methods and apparatuses for the analysis and detection of nanoparticles in a liquid from a semiconductor manufacturing component are provided herein. In some embodiments, a method of identifying chemical and spatial properties of nanoparticles in a semiconductor cleaning solution is provided. The method includes contacting a semiconductor cleaning solution with a semiconductor component to form a mixture comprising one or more insoluble analytes-of-interest. The method further includes projecting an excitation beam of light from a broadband light source onto the mixture to induce one or more fluorescence signals and forming a plurality of images from the one or more fluorescence signals. The method further includes detecting spatial properties of the one or more insoluble analytes-of-interest through analysis of spatial data captured in the plurality of images and identifying the one or more insoluble analytes-of-interest with the spatial properties detected through analysis of spectral data captured in the plurality of images.

In other embodiments, an apparatus to identify chemical and spatial properties of nanoparticles in a semiconductor cleaning solution is provided. The apparatus also includes a broadband light source to provide an excitation beam, a focusing lens in a path of the excitation beam to form a focused excitation beam, a sample cell, a plurality of optical lens in the path of one or more fluorescence signals to focus the one or more fluorescence signals, and an imaging device. The sample cell is configured to hold a cleaning solution and one or more insoluble analytes-of-interest therein. The imaging device captures the one or more fluorescence signals to form a plurality of images that contain both spatial data and spectral data about the one or more insoluble analytes-of-interest.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1A-1B depict an apparatus for contacting a semiconductor processing chamber component with a cleaning solution, in accordance with some embodiments of the present disclosure.

FIG. 2 depicts a flow chart of a method for gathering spectral and spatial data, in accordance with some embodiments of the present disclosure.

FIG. 3A depicts an apparatus to identify chemical and spatial properties of nanoparticles in a semiconductor processing chamber component cleaning solution in accordance with some embodiments of the present disclosure.

FIG. 3B-3C depict fluorescence and Raman scattering information.

FIG. 4A-4C depict optical data used to help identify the chemical and spatial properties of the nanoparticles in a cleaning solution in accordance with some embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Methods and apparatuses for the analysis and detection of particles in a liquid (e.g. cleaning solution) from a semiconductor manufacturing component are provided herein. The methods and apparatus described herein advantageously provide determination of both the chemical and spatial properties of nanoparticles in a semiconductor processing chamber component cleaning solution from a single apparatus that includes a single sensor imaging device. Furthermore, the methods described herein significantly improve detection of chamber line reactions or any other parasitic reaction between process gases that lead to coatings of undesirable non-volatile byproducts and contaminants on process tools and chambers. Moreover, quantitative and qualitative information obtained using methods and apparatuses of the present disclosure about contaminants from microelectronic manufacturing chambers and parts thereof may be used to modify cleaning solutions to enhance overall cleaning performance.

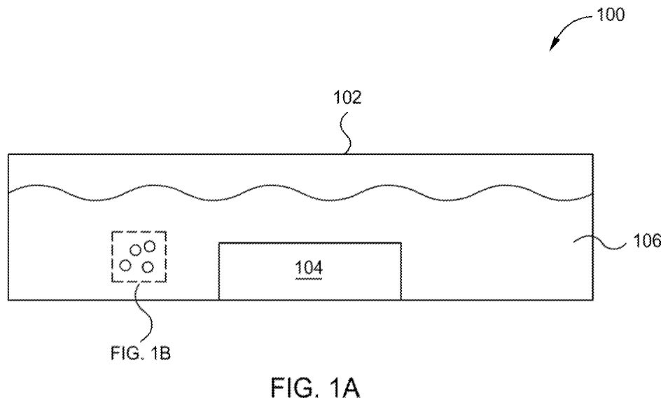

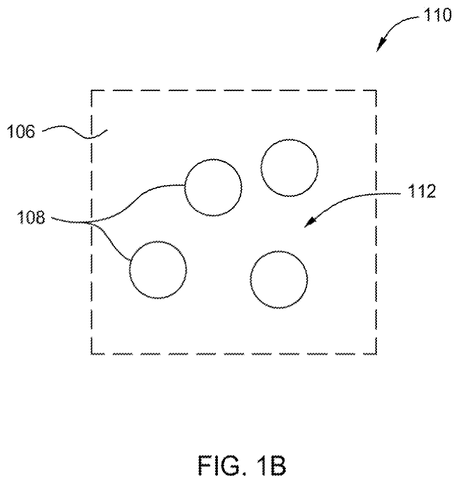

FIG. 1A-1B depict an apparatus 100 for contacting a semiconductor processing chamber component 104 with a cleaning solution 106 to extract nanoparticles 108 from the semiconductor processing chamber component 104. The apparatus 100 includes a cleaning tank 102 that is designed to hold a variety of semiconductor processing chamber components as well as a volume of a cleaning solution 106. Some examples of the variety of semiconductor processing chamber components that may be placed inside the cleaning tank 102 are a chamber liner, a chamber shield, or a susceptor.

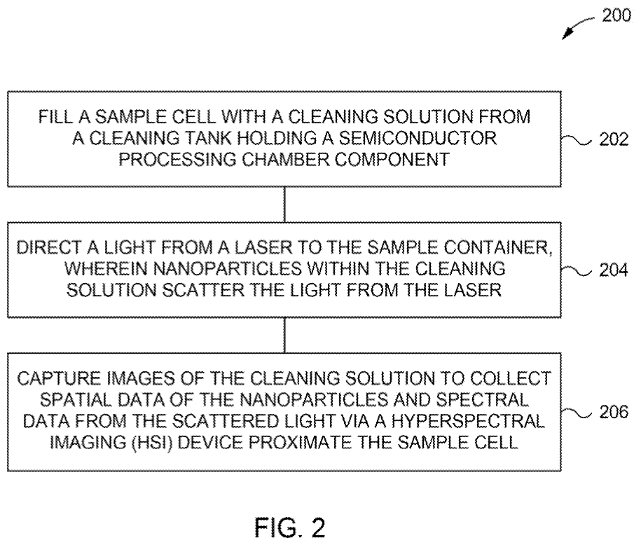

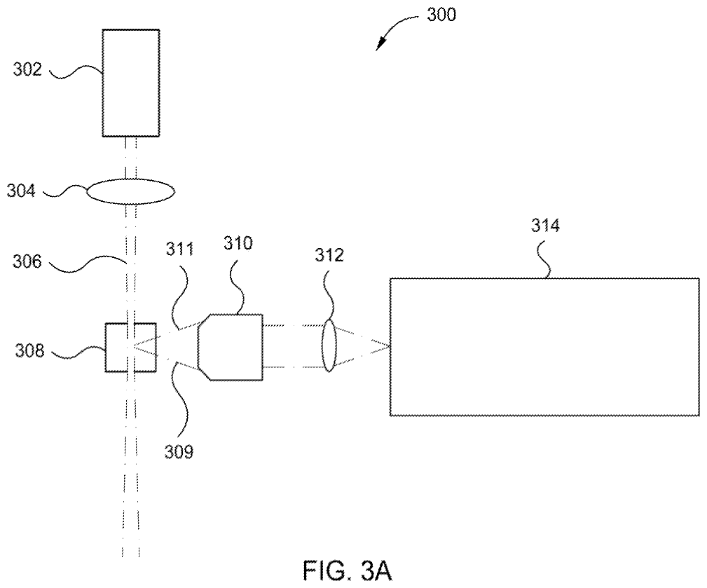

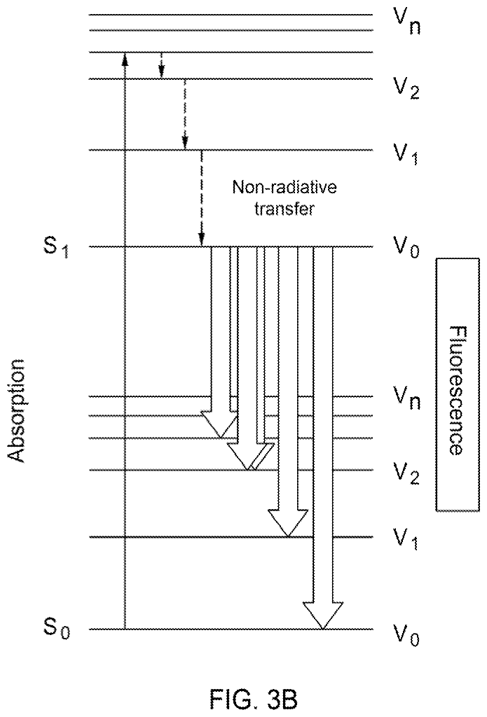

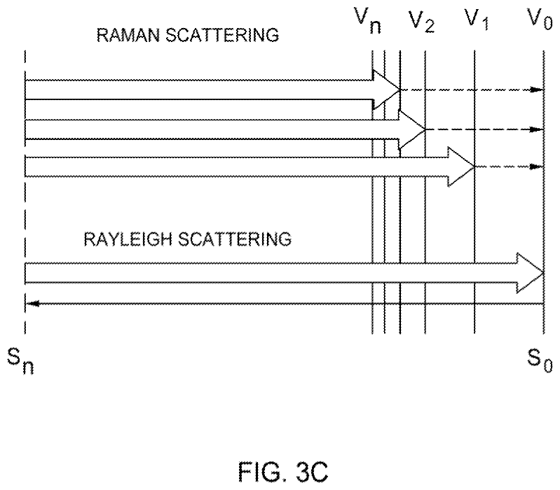

FIG. 2 depicts a flow chart of a method 200 for gathering spectral and spatial data about nanoparticles contained in a sample of cleaning solution in accordance with some embodiments of the present disclosure. For ease of explanation, FIG. 2 will be explained with reference to FIGS. 1A-1B and 3A, although it is to be understood that the described methods are applicable to other apparatuses. The method 200 begins at operation 202 by filling a sample cell 308 (as shown in FIG. 3A) with a sample 110 of the cleaning solution 106 collected from the cleaning tank 102, shown in FIG. 1A. The sample 110 of the cleaning solution 106 contains a concentration 112 of a plurality of nanoparticles 108 that have been removed from a plurality of surfaces of the semiconductor processing chamber component 104 displaced in the cleaning tank 102.

Next, at operation 204, after the sample cell 308 containing the sample 110 of the cleaning solution 106 has been positioned in an apparatus 300 for identifying chemical and spatial properties of nanoparticles, an incident excitation beam of light 306 is directed toward the sample cell 308 (as shown in FIG. 3A). Due to the Brownian motion of the plurality of nanoparticles 108 moving within the cleaning solution, a portion of the incident excitation beam of light 306 is scattered into scattered light 309. Most of the scattered light 309 is elastically scattered, also known as Rayleigh scattering, such that a plurality of scattered photons of the scattered light 309 have the same energy (e.g., one or more of frequency, wavelength, color) as a plurality of incident photons from the incident excitation beam of light 306. An even smaller portion of the scattered light 309 are scattered inelastically, such that a plurality of scattered photons of the scattered light 309 have different energy (e.g., one or more of frequency, wavelength, color) as the plurality of incident photons from the incident excitation beam of light 306. The smaller portion of the scattered light 309 that is inelastically scattered has a frequency that is shifted from the incident excitation beam of light 306.

Next, at operation 206, a set of images are captured via a high-resolution imaging device 314. In some embodiments, the high-resolution imaging device 314 is a hyperspectral imager (HSI). The high-resolution imaging device 314 is designed to collect both spatial and spectral data with each image the high-resolution imaging device 314 records. The spatial data from each image is used to determine a set of spatial properties of the plurality of nanoparticles 108 contained in the sample 110 of the cleaning solution 106. The set of spatial properties of the plurality of nanoparticles 108 determined by the collected spatial data may include the size, shape, and count/concentration. The spectral data from each image is used to determine a set of spatial and chemical properties of the plurality of nanoparticle 108. The set of spatial and chemical properties of the plurality of nanoparticles 108 that can be determined by the collected spectral data may include the molecular weight, the chemical composition, the size, and the count/concentration of the plurality of nanoparticles 108. The spectral data is based upon the portion of the scattered light 309 that has been scattered inelastically after a plurality of incident photons from the incident excitation beam of light 306 contacts the plurality of nanoparticles 108. The spatial and spectral data recorded in each image by the high-resolution imaging device 314 are both processed using a variety of image analysis algorithms, such as thresholding and binning, blob detection, and the like, in order to accurately determine the size, concentration, and chemical composition of the plurality of nanoparticles 108. In some embodiments, the high-resolution imaging device 314 can be positioned 90 degrees relative to illumination to detect the scattered light 309 to determine spatial and chemical properties of the plurality of nanoparticles 108. In some embodiments, the high-resolution imaging device 314 is positioned proximate the sample cell 308.

FIG. 3A depicts an apparatus 300 to identify chemical and spatial properties of nanoparticles in a semiconductor processing chamber component cleaning solution in accordance with some embodiments of the present disclosure. The apparatus 300 is configured for spatial imaging, molecule fluorescence imaging, and spectroscopy that can be used to chemically and spatially identify particles (e.g., nanoparticles) and/or other analytes-of-interest.

The apparatus 300 comprises a broadband light source 302. In some embodiments, the broadband light source is a tunable diode-pumped solid-state (DPSS) laser. The laser is a continuous wave laser providing less than 1 W of power. The broadband light source 302 is tunable in the UV-visible-NIR region, such as between 200 to 500 nanometers, or between 390 to 2400 nanometers, to excite different electronic excitation modes for different nanoparticles. The broadband light source 302 provides a coherent near-monochromatic light (i.e. an excitation beam 306) which passes through a focusing lens 304. The excitation beam 306 is then directed to a sample cell 308 that contains a sample 110 of the cleaning solution 106 taken from the cleaning tank 102. The sample 110 of the cleaning solution 106 includes a volume of cleaning solution or other agents, such as surfactants, as well as a concentration 112 of the plurality of nanoparticles 108 removed from surfaces of the semiconductor processing chamber component 104. A portion of the incident excitation beam 306 comes into contact with the plurality of nanoparticles 108 and excites the nanoparticle molecules. The excited nanoparticles absorb some of the energy from a plurality of photons from the incident excitation beam 306 before emitting scattered light 309. The scattered light 309 emitted by the nanoparticles as well as a reflected light 311 of the sample 110 of the cleaning solution 106 is passed through a plurality of optical lens. In some embodiments, the plurality of optical lens includes an objective lens 310 and a tube lens 312. The objective lens 310 and the tube lens 312 are positioned in an infinite conjugate optical configuration to focus the scattered light 309 and reflected light 311 onto an image sensor of the high-resolution imaging device 314. A set of images are then captured and recorded by the high-resolution imaging device 314 over time as the scattered light 309 and the reflected light 311 are continuously projected onto the image sensor of the high-resolution imaging device 314.

The high-resolution imaging device 314 utilizes a hyperspectral imaging sensor that analyzes a wide spectrum of light, in contrast to standard imaging systems that simply assign primary colors: red, green, or blue, to each pixel. The scattered light 309 and reflected light 311 captured by each pixel of a recorded image by the high-resolution imaging device 314 is broken down into many different spectral bands. Unlike other optical technologies that can only scan for a particular color, hyperspectral imaging sensors are able to distinguish the full color spectrum in each pixel. Therefore, hyperspectral imaging sensors provide both spectral information and spatial information with each image the hyperspectral imaging sensors capture. Hyperspectral imaging sensors simplify the nanoparticle metrology apparatus into one compact apparatus because the sensors eliminate the need for two separate metrology apparatuses: one apparatus designed to capture high-resolution images to detect the sizes and concentrations of the nanoparticles, and one apparatus designed to capture spectral data with a high-resolution spectrometer. The high-resolution imaging device 314 equipped with a hyperspectral imaging sensor also significantly reduces the cost of the overall nanoparticle metrology apparatus. For example, use of hyperspectral imaging sensor can result in a savings of 50% or more over conventional apparatuses.

Since each pixel of a captured image from the high-resolution imaging device 314 contains both spectral data as well as spatial data, three-dimensional data cubes can be generated in which a first dimension and a second dimension represent the spatial data while a third dimension represents the spectral data. Hyperspectral three-dimensional data cubes may contain absorption, reflectance, or fluorescence spectrum data for each image pixel. Post-processing of hyperspectral images enables calibration of the spectral curves for every pixel contained in the recorded image. A set of spectral curves can be extracted from all desired locations of an image, then plotted on the same graph, and later processed to determine the differences between the set of spectral curves. Machine learning algorithms and other image analysis algorithms can be applied to extract hyperspectral three-dimensional data. In some embodiments, the machine learning and image analysis algorithms include principal component analysis, color deconvolution, and image subtraction and multiplication.

The hyperspectral imaging sensor captures spatial and spectral data from the scattered light 309 and reflected light 311 in each pixel of a captured image. The reflected light 311 of the sample 110 of the cleaning solution 106 contained in the sample cell 308 is captured by the hyperspectral imaging sensor to be used as spatial data and later processed to form a first and a second spatial dimension of a hyperspectral three-dimensional data cube. The spatial data collected over time is post-processed to determine a set of spatial properties of the plurality of nanoparticles 108 present in the sample 110 of the cleaning solution 106. In some embodiments, the set of spatial properties of the plurality of nanoparticles 108 determined by the collected spatial data includes the size and concentration. The scattered light 309 generated by the inelastic scattering of photons (also known as Raman scattering or the Raman effect) after the incident excitation beam of light 306 contacts the plurality of nanoparticles 108 is captured by the hyperspectral imaging sensor of the high-resolution imaging device 314 to be used as spectral data. The scattered light 309 is captured by the hyperspectral imaging sensor of the high-resolution imaging device 314 over time to be used as spectral data and later processed to form a third spectral dimension of a hyperspectral three-dimensional data cube. The spectral data collected over time is post-processed to determine a set of chemical properties of the plurality of nanoparticles 108 present in the sample 110 of the cleaning solution 106 based on the spatial properties identified by the two-dimensional spatial data collected in each pixel of the plurality of captured images.

Fluorescence and Raman imaging are optically sensitive methods for chemically identifying nanoparticles that are present in a solution such as deionized water, or a cleaning solution containing, for example, surfactants. As depicted in FIG. 3B, the absorption of radiation in UV-visible wavelength (e.g., 200-500 nm) excites molecules to higher excited electronic states (e.g. from S₀ (ground) to S₁, S₂, S₃, . . . Sₙ). The excited molecules can either relax to a ground state, S₀, directly or to lower states through radiationless energy transfer. Fluorescence emission occurs only from S₁ to S₀. Maximum fluorescence occurs when a molecule is excited at the excitation wavelength. Usually fluorescence occurs at a wavelength significantly red shifted (e.g., an increase in wavelength) from the excitation wavelength. Metal nanoparticles such as those that exhibit strong plasmonic resonances (e.g. copper, gold, aluminum) show distinct fluorescence emissions when excited at correspondingly specific excitation wavelengths in the UV-visible region with a tunable laser, and are thus detectable and identifiable using methods and apparatuses of the present disclosure.

When a sample cell, such as the one in apparatus 300, is exposed to a monochromatic light in the visible region, the sample cell and/or the sample therein absorbs light. A small portion of the absorbed light is scattered by a plurality of nanoparticles contained in the sample cell. When the photons from the incident light comes into contact with the plurality of nanoparticles, energy is transferred to the electrons of the nanoparticles which causes the electrons of the nanoparticles to vibrate. Most of the scattered light emitted from the vibration of the nanoparticle electrons has the same frequency as the incident light known as Rayleigh scattering. However, a small fraction of the total scattered light emitted from the vibration of the nanoparticle electrons have frequencies different from the incident light frequency. This form of inelastic scattering of light is called Raman scattering. As depicted in FIG. 3C, Raman scattering may occur from a higher excited state to a resonant vibrational state of the ground electronic state as a result of inelastic scattering of light by excited molecules, causing a shift in the spectrum, unique for different materials such as contaminants or nanoparticles. In embodiments of the present disclosure, both metal and non-metal analytes-of-interest may exhibit Raman scattering signals which can be detected by the apparatus 300 of FIG. 3A and captured as spectral image data by the high-resolution imaging device 314. In some embodiments, the metal analytes-of-interest may include copper (Cu), gold (Au), aluminum (AI), nickel (Ni), chromium (Cr), nichrome (NiCr), germanium (Ge), silver (Ag), titanium (Ti), tungsten (W), platinum (Pt), tantalum (Ta), or any combination thereof. In other embodiments, the non-metal analytes-of-interest may include metal oxide, metal fluoride, nitride, or any combination thereof.

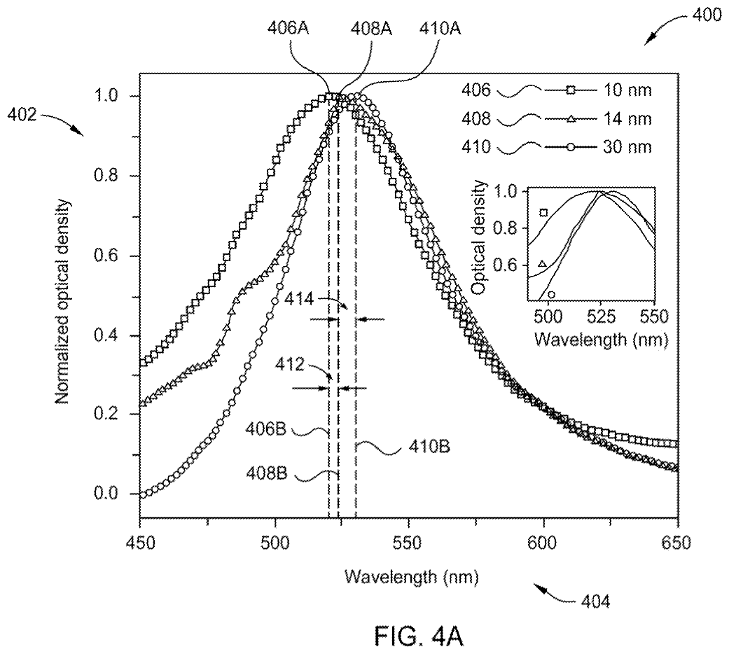

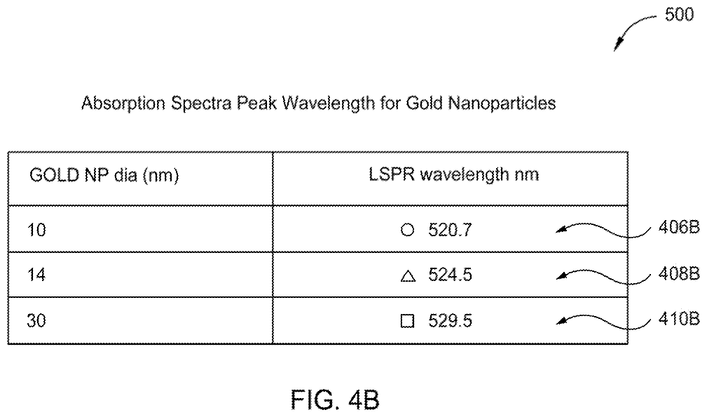

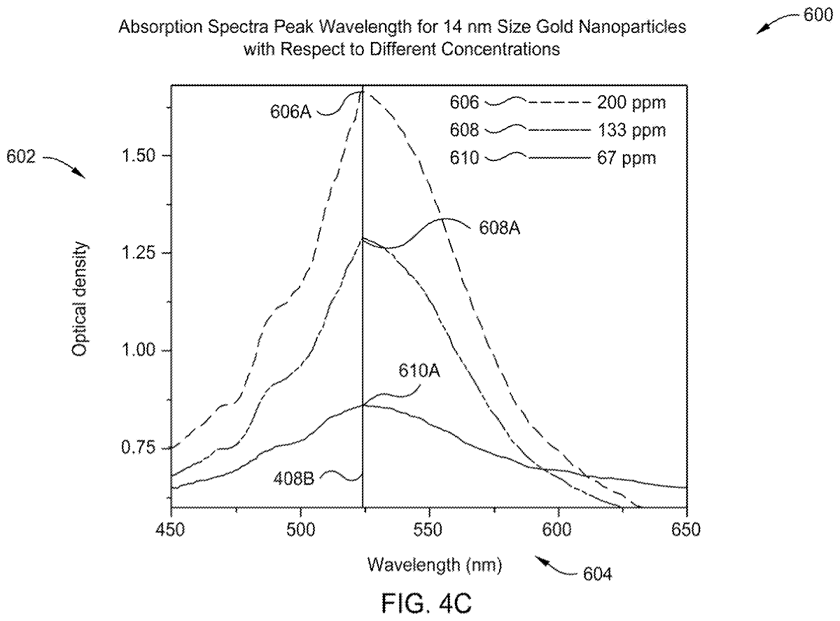

FIG. 4A-4C depict information (e.g., empirically derived) used to help identify the chemical and spatial properties of the nanoparticles in a semiconductor processing chamber component cleaning solution in accordance with some embodiments of the present disclosure. FIG. 4A illustrates an absorption spectra graph 400. Absorption spectra data is collected in a plurality of controlled experiments via an imaging device. In some embodiments, the imaging device is a high-resolution imaging device capable of performing hyperspectral imaging that collects both two-dimensional spatial data and one-dimensional spectral data. The plurality of controlled experiments collects spectral data on a wide variety of nanoparticles and a range of nanoparticle sizes. The absorption spectra data for each specific nanoparticle can be plotted on a graph such as the absorption spectra graph 400 provided in FIG. 4A to visualize the spectra profiles with respect to variations in nanoparticle sizes. The absorption spectra graphs may contain a plurality of curves, where each of the plurality of curves represent a distinct nanoparticle diameter size. The curves represent the optical density (i.e. absorption intensity) over a range of excitation wavelengths of light that induce Raman scattering.

The absorption spectra graph 400 represents the data collected in a controlled experiment to measure the absorption spectra of gold nanoparticles with respect to varying sizes in diameter. The absorption spectra graph 400 describes the relationship between a normalized optical density 402 and wavelength 404 with respect to the diameter size of the nanoparticles. The absorption spectra graph 400 contains three spectra curves related to the diameter size of the gold nanoparticles measured in nanometers. A first spectra curve 406 represents the absorption spectra curve for 10 nm gold nanoparticles, a second spectra curve 408 represents the absorption spectra curve for 14 nm gold nanoparticles, and a third spectra curve 410 represents the absorption spectra curve for 30 nm gold nanoparticles. Each of the three spectra curves have been normalized by dividing each data point across a range of wavelengths by the maximum optical density value of the respective spectra curve in order to compare the resonant peaks amongst the three curves. As seen in the absorption spectra graph 400, the first spectra curve 406 has a first optical density peak 406A at a first wavelength 406B, the second spectra curve 408 has a second optical density peak 408A at a second wavelength 408B, and the third spectra curve 410 has a third optical density peak 410A at a third wavelength 410B.

The results of the absorption spectra peak wavelength for gold nanoparticles can be seen in table 500 in FIG. 4B. The maximum absorption of incident light for the first spectra curve 406 representing 10 nm gold nanoparticles occurs at a first wavelength 406B with a value of 520.7 nm. The second spectra curve 408 representing 14 nm gold nanoparticles has a maximum absorption of incident light at a second wavelength 408B with a value of 524.5 nm. The third spectra curve 410 representing 30 nm gold nanoparticles has a maximum absorption of incident light at a third wavelength 410B with a value of 529.5 nm. Thus, a first shift 412 in peak absorption wavelength occurs between the first spectra curve 406 and the second spectra curve 408, and a second shift 414 occurs between the second spectra curve 408 and the third spectra curve 410. The first and second shifts 412, 414 in peak absorption wavelength indicate that the diameter sizes of the gold nanoparticles influence the results of the peak absorption wavelength. The variation in maximum absorption of light based on the nanoparticle diameter size occurs for all types nanoparticles, just like the gold nanoparticles with different diameter sizes visualized in FIG. 4A. Therefore, in order to accurately determine the chemical composition of the plurality of nanoparticles 108 in the sample cell 308 with the images captured by the high-resolution imaging device 314 capable of assigning spatial and spectral data to each pixel of each image, qualitative imaging analysis must first be performed on the two-dimensional spatial data to determine the nanoparticle diameter size.

To further identify the chemical and spatial properties of nanoparticles from a sample mixture containing nanoparticles, such as the sample 110 contained in a sample cell 308 of FIG. 3A, absorption versus concentration may be considered. FIG. 4C depicts an absorption spectra graph 600. The absorption spectra graph 600 describes the relationship between non-normalized optical density 602 and wavelength 604 with respect to different nanoparticle concentrations. A first spectra curve 606 represents the absorption spectra curve for 14 nm gold nanoparticles with a concentration of 200 parts-per-million (ppm). A second spectra curve 608 represents the absorption spectra curve for 14 nm gold nanoparticles with a concentration of 133 ppm. A third spectra curve 610 represents the absorption spectra curve for 14 nm gold nanoparticles with a concentration of 67 ppm. As seen in the absorption spectra graph 600, since the plotted spectral data represents 14 nm gold nanoparticles like the spectral data that represents the second spectra curve 408 on the absorption spectra graph 400 in FIG. 4A, each of the three spectra curves 606, 608, 610 on the absorption spectra graph 600 have absorption peaks at the same wavelength as the second wavelength 408B from FIG. 4A with a value of 524.5 nm. Since the absorption spectra graph 600 has a non-normalized optical density the difference between optical density intensity can be visualized amongst the different spectra curves that represent different variations of nanoparticle concentration. For example, the first spectra curve 606 has a first optical density peak 606A slightly above 1.625, the second spectra curve 608 has a second optical density peak 608A slightly above 1.25, and the third spectra curve 610 has a third optical density peak 610A slightly below 0.875. The first spectra curve 606 has the highest optical density peak, the second spectra curve 608 has the second highest optical density peak, and the third spectra curve 610 has the lowest optical density peak. This correlation between peak optical density and nanoparticle concentration indicates that the higher the nanoparticle concentration, the higher the intensity of light absorption.

While the graphs and table in FIG. 4A-4C depict the absorption spectrum for only gold nanoparticles, similar methods and data are applicable to other metal and non-metal contaminants. Other non-limiting examples of particles may include silicon, aluminum nitride, copper, silicon oxide, titanium oxide, aluminum oxide, yttrium oxide, silicon nitride, iron oxide, titanium nitride, and silicon carbide.

Returning to FIG. 3A, after the high-resolution imaging device 314 records a plurality of hyperspectral images with a hyperspectral imaging sensor to obtain spatial and spectral data in the form of a three-dimensional hyperspectral data cube and a set of post-processing machine learning and imaging analysis algorithms are performed on the captured hyperspectral images to calibrate the spectral curves of each pixel, the spatial and spectral data can be analyzed by different quantitative and qualitative analysis techniques to determine a set of spatial properties and a set of chemical properties of the unknown nanoparticles disposed inside the sample 110. The two-dimensional spatial data from each hyperspectral image is processed to determine the nanoparticle size and the concentration of nanoparticles relative to the sample size of the sample 110. After the nanoparticle size and concentration have been determined from the two-dimensional spatial data, the spectral data can be analyzed to determine the maximum optical density (i.e. the maximum absorption of light) and the corresponding absorption wavelength. Based on the results of the nanoparticle size, concentration, maximum optical density, and absorption wavelength determined by the analysis of the spatial and spectral data of the hyperspectral images, the results can be cross-referenced with the sets of values contained in a nanoparticle spectral library, to identify the chemical composition of the plurality of nanoparticles 108.

While the foregoing is directed to embodiments of the present disclosure, other and further embodiments of the disclosure may be devised without departing from the basic scope thereof, and the scope thereof is determined by the claims that follow.

What is claimed is:

1. A method of identifying chemical and spatial properties of nanoparticles in a semiconductor cleaning solution, comprising:
contacting a semiconductor cleaning solution with a semiconductor manufacturing component;
projecting an excitation beam of light from a broadband light source onto a mixture to induce one or more fluorescence signals;
forming a plurality of images from the one or more fluorescence signals;
detecting spatial properties of one or more insoluble analytes-of-interest through analysis of spatial data captured in the plurality of images using a hyperspectral image; and
identifying the one or more insoluble analytes-of-interest with the spatial properties detected and through analysis of spectral data captured in the plurality of images.

2. The method of claim 1, wherein the excitation beam is projected from a tunable diode-pumped solid-state (DPSS) laser.

3. The method of claim 1, wherein the one or more insoluble analytes-of-interest comprise a metal.

4. The method of claim 3, wherein the metal is copper (Cu), gold (Au), aluminum (Al), nickel (Ni), chromium (Cr), nichrome (NiCr), germanium (Ge), silver (Ag), titanium (Ti), tungsten (W), platinum (Pt), tantalum (Ta), or any combination thereof.

5. The method of claim 1, wherein the one or more insoluble analytes-of-interest comprise a non-metal.

6. The method of claim 5, wherein the non-metal is an oxide, a fluoride, a nitride, or combinations thereof.

7. The method of claim 1, wherein the one or more insoluble analytes-of-interest comprise a metal and a non-metal.

8. The method of claim 1, wherein the detecting spatial properties of the one or more insoluble analytes-of-interest comprises detecting using one or more of absorption, reflection, fluorescence, or Raman scattering phenomena.

9. The method of claim 1, wherein the spatial properties of the one or more insoluble analytes-of-interest is selected from the group consisting of size, shape, count and concentration.

10. The method of claim 1, wherein the spectral data captured in the plurality of images includes optical density and absorption wavelength.

11. The method of claim 1, wherein the one or more insoluble analytes-of-interest is selected from the group consisting of silicon, aluminum nitride, copper, silicon oxide, titanium oxide, aluminum oxide, yttrium oxide, silicon nitride, iron oxide, titanium nitride, and silicon carbide.

12. The method of claim 1, wherein the cleaning solution contains surfactants.

13. The apparatus of claim 12, wherein the cleaning solution comprises deionized water.

14. An apparatus to identify chemical and spatial properties of nanoparticles in a semiconductor cleaning solution, comprising:
a broadband light source to provide an excitation beam;
a focusing lens in a path of the excitation beam to form a focused excitation beam;
a sample cell, the sample cell configured to hold a cleaning solution and one or more insoluble analytes-of-interest therein;
a plurality of optical lens in the path of one or more fluorescence signals to focus the one or more fluorescence signals; and
an imaging device, wherein the imaging device captures the one or more fluorescence signals to form a plurality of images that contain both spatial data and spectral data about the one or more insoluble analytes-of-interest.

15. The apparatus of claim 14, wherein the imaging device comprises a hyperspectral imaging sensor.

16. The apparatus of claim 14, wherein the broadband light source is a diode-pumped solid-state (DPSS) laser.

17. The apparatus of claim 16, wherein the diode-pumped solid-state (DPSS) laser provides less than 1 W of power.

18. The apparatus of claim 16, wherein the diode-pumped solid-state (DPSS) laser is tunable in the UV-visible-NIR region.

19. The apparatus of claim 14, wherein the solution comprises surfactants.

20. The apparatus of claim 14, wherein the solution is deionized water.
